(19) United States
(12) Patent Application Publication
(10) Pub. No.: US 2002/0143585 A1
(43) Pub. Date: Oct. 3, 2002

(54) Apparatus and method for determining insurance and program thereof

(76) Inventors: Ryuichiro Kodama, Tokyo (JP); Michiaki Mori, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 10/063,160

(22) Filed: Mar. 27, 2002

(30) Foreign Application Priority Data
Mar. 29, 2001 (JP) 2001-095488

(51) Int. Cl. G06F 17/60

(52) U.S. Cl. 705/4

(57) ABSTRACT

An apparatus that supports determination by a user of optimal insurance to avoid unnecessary insurance coverage and excessive insurance premium for an insured object. Expected insurance compensation, which is money expected to be paid for the insured object from other insurance when an insured incident occurs, is calculated by referring to other insurance relative to the insured object. A setting unit sets a premium for insurance sought for the insured object using the calculated expected-insurance-money value. A user is provided with insurance premium that is determined based upon quantitative consideration of other insurance coverage.

### CROSS REFERENCE TO RELATED APPLICATIONS

This patent application claims priority from a Japanese patent application No. 2001-095488 filed on Mar. 29, 2001, the contents of which are incorporated herein by reference.

### BACKGROUND OF INVENTION

1. Field of the Invention

The present invention relates to an apparatus that supports determination of insurance sought by a user, a method for determining insurance, and a program thereof stored in a computer readable medium. More particularly, the present invention relates to determining optimal insurance premium for an object sought to be insured, i.e., an insured object, using other insurance data to prevent the user carrying excessive insurance or paying double premium for insurance on the insured object.

2. Description of the Related Art

Conventionally, when a customer obtains new insurance, the customer judges approximately how much compensation money the customer can expect for the object of the insurance, from insurance that has been already carried by the customer, based on the maximum payment-limit-amount, i.e., the compensation limit, of the other insurance.

However, the above-mentioned conventional method does not consider quantitatively, i.e., in numerical terms, how much compensation can be expected for the insured object as paid by the new insurance and the other insurance carried by the customer.

In other words, the conventional method does not consider quantitatively how much risk hedge can be expected for the object of the insurance from other insurance coverage carried by the customer. Therefore, conventionally it was difficult to prevent a customer carrying excessive insurance for the same insured object. Also, it was difficult to prevent the customer paying double or excessive premium for the same insured object.

### SUMMARY OF INVENTION

Therefore, it is an object of the present invention to provide an apparatus, a method, and a program thereof for supporting insurance determination, which are capable of overcoming the above drawbacks accompanying the conventional art. The above and other objects can be achieved by combinations described in the independent claims. The dependent claims define further advantageous and exemplary combinations of the present invention.

According to a first aspect of the present invention, an apparatus that supports a user in determining insurance that the user seeks for an insured object, comprises: a first calculation unit that calculates an expected amount of insurance money, which is insurance money expected to be paid for the object of the insurance from other insurance; and a setting unit that sets a premium for the insurance sought for the object using the expected-insurance-money calculated by the first calculation unit.

The setting unit may include: a second calculation unit that calculates a payment-limit-amount, which is a compensation amount of insurance money to be paid to the user by the insurance sought for the object, using the expected-insurance-money; and a premium calculation unit that calculates the premium for the insurance sought for the object using the payment-limit-amount.

The first calculation unit may receive information related to the insured object and may calculate the expected-insurance-money using the received information; and the second calculation unit may receives a requested payment-limit-amount for the insured object, which is a compensation amount of insurance sought by the user related to the insured object, and may calculate the payment-limit-amount using the requested payment-limit-amount and the expected-insurance-money.

The apparatus may refer to insurance that insures the insured object, except the insurance sought for the object, as the other insurance. The apparatus may refer to insurance that insures objects other than the insured object, as the other insurance.

The first calculation unit may include a probability calculation unit that calculates a probability of receiving insurance money from the other insurance that insures the other insured objects; and the first calculation unit may calculate the expected-insurance-money using the probability calculated by the probability calculation unit.

The first calculation unit may calculate the expected-insurance-money for each of a plurality of the insured objects, when there is the plurality of the insured objects; and the second calculation unit may calculate the payment-limit-amount using the each calculated expected-insurance-money; and the premium calculation unit may calculate the premium using the payment-limit-amount for each insured object of the plurality of insured objects.

The premium calculation unit may calculate a total premium amount, which is a total amount of the premium for the insurance sought for the object and premiums for the other insurance paid by the user, recalculate the expected-insurance-money and the payment-limit-amount so that the total premium becomes a minimum value, and recalculate the premium for the insurance sought for the object and the premiums for the other insurance based on the recalculated expected-insurance-money and the payment-limit-amount.

The setting unit may include a discount setting unit that sets a discount rate or a discount amount, using the expected-insurance-money, for the premium for the insurance sought for the insured object; and a premium calculation unit that calculates the premium for the insurance sought for the object using the discount rate or the discount amount.

The first calculation unit may receive information related to the insured object and calculate the expected-insurance-money using the received information; and the discount setting unit may receive a requested payment-limit-amount for the insured object, which is a compensation amount of insurance sought by the user related to the insured object, and may set the discount rate or the discount amount for the premium using the requested payment-limit-amount and the expected-insurance-money.

The first calculation unit may calculate the expected-insurance-money for each of a plurality of the insured objects, when there is the plurality of the insured objects; and the discount setting unit may set the discount rate or the discount amount using the each calculated expected-insurance-money; and the premium calculation unit may calculate the premium using the discount rate or the discount amount for each of the plurality of insured objects.

According to a second aspect of the present invention, a method for supporting a user in obtaining insurance that the user seeks for an insured object, comprises: calculating an expected amount of insurance money, which is insurance money expected to be paid for the object of the insurance from other insurance; calculating a premium for the insurance sought for the object using the expected-insurance-money amount; and notifying the calculated premium to the user who seeks insurance for the insured object.

The step of calculating the premium may include calculating a payment-limit-amount, which is a compensation amount of insurance money to be paid to the user by the insurance sought for the object, using the expected-insurance-money; and calculating the premium for the insurance sought for the object using the payment-limit-amount.

The step of calculating the expected-insurance-money may receive information related to the insured object and may calculate the expected-insurance-money using the received information; and the step of calculating the payment-limit-amount may receive a requested-payment-limit-amount for the insured object, which is a compensation amount of insurance sought by the user related to the insured object, and may calculate the payment-limit-amount using the requested-payment-limit-amount and the expected-insurance-money.

The step of calculating the expected-insurance-money may refer to insurance that insures the insured object, except the insurance sought for the object, as the other insurance. The step of calculating the expected-insurance-money may refer to insurance that insures objects other than the insured object, as the other insurance.

The step of calculating the expected-insurance-money may include calculating a probability of receiving insurance money from the other insurance that insures the other insured objects; and the step of calculating the expected-insurance-money may calculate the expected-insurance-money using the calculated probability.

The step of calculating the expected-insurance-money may calculate the expected-insurance-money for each of a plurality of the insurance objects when there is a plurality of the insurance objects; and the step of calculating the payment-limit-amount may calculate the payment-limit-amount using the each calculated expected-insurance-money; and the step of calculating the premium may calculate the premium using the payment-limit-amount for each of the plurality of insurance objects.

The step of calculating the premium may calculate a total premium amount, which is a total amount of the premium for the insurance sought for the object and premiums for the other insurance paid by the user, may recalculate the expected-insurance-money and the payment-limit-amount so that the total premium becomes a minimum value, and may calculate the premium for the insurance sought for the object and the premiums for the other insurance based on the recalculated expected-insurance-money and the payment-limit-amount.

The step of calculating the premium may include setting a discount rate or a discount amount, using the expected-insurance-money, for the premium for the insurance sought for the insured object; and calculating the premium for the insurance sought for the object using the discount rate or the discount amount.

The step of calculating the expected-insurance-money may receive information related to the insured object and calculate the expected-insurance-money using the received information; and the step of setting the discount rate or a discount amount may receive a requested-payment-limit-amount for the insured object, which is a compensation amount of insurance sought by the user related to the insured object, and may set the discount rate or the discount amount for the premium using the requested-payment-limit-amount and the expected-insurance-money.

The step of calculating the expected-insurance-money may calculate the expected-insurance-money for each of a plurality of the insured objects when there is a plurality of the insured objects; and the step of setting the discount may set the discount rate or the discount amount using the each calculated expected-insurance-money; and the step of calculating the premium may calculate the premium using the discount rate or the discount amount for each of the plurality of insured objects.

According to a third aspect of the present invention, a recording medium that stores a program executable by a computer for supporting a user in determining insurance, comprises: a first calculation module operable to calculate an expected amount of insurance money, which is insurance money expected to be paid for an object of the insurance sought by the user, from other insurance when a covered incident occur related to the object; and a premium calculation module operable to calculate a premium for the insurance sought for the object using the expected-insurance-money amount calculated by the first calculation module.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 shows a configuration of an insurance-determination-supporting apparatus 200 according to one embodiment of the present invention.

FIG. 2 shows an example of a configuration of the statistics database 220 according to the present embodiment.

FIG. 3 shows an example of the premium-rate database 240 according to the present embodiment.

FIG. 4 shows other examples of the premium-rate database 240 according to the present embodiment.

FIG. 5 shows an example of the operation of the insurance-determination-supporting apparatus 200 in FIG. 1, according to the present embodiment.

FIG. 6 shows an example of a detailed flow-chart for Step 20 in FIG. 5.

FIG. 7 shows a detailed example of Step 100 shown in FIG. 6.

FIG. 8 shows a table for explaining the calculation according to the operation of the expected-insurance-money calculation unit 260 shown in FIG. 1.

FIG. 9 shows a detailed example of Step 200 shown in FIG. 6.

FIG. 10 shows a configuration of hardware of the insurance-determination-supporting apparatus 200 according to one embodiment of the present invention.

FIG. 11 shows a configuration of another embodiment of the insurance-determination-supporting apparatus according to the present invention.

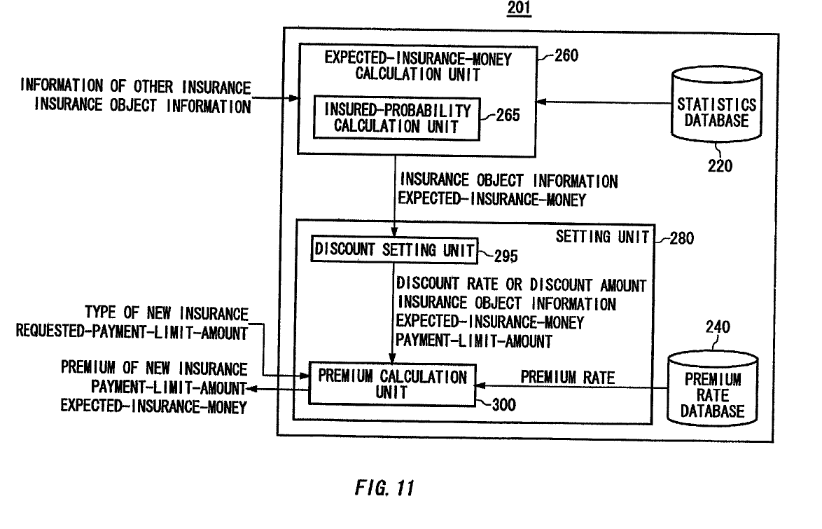

FIG. 12 shows a configuration of yet another embodiment of the insurance-determination-supporting apparatus according to the present invention.

### DETAILED DESCRIPTION

The invention will now be described based on the preferred embodiments, which do not intend to limit the scope of the present invention, but exemplify the invention. All of the features and the combinations thereof described in the embodiments are not necessarily essential to the invention.

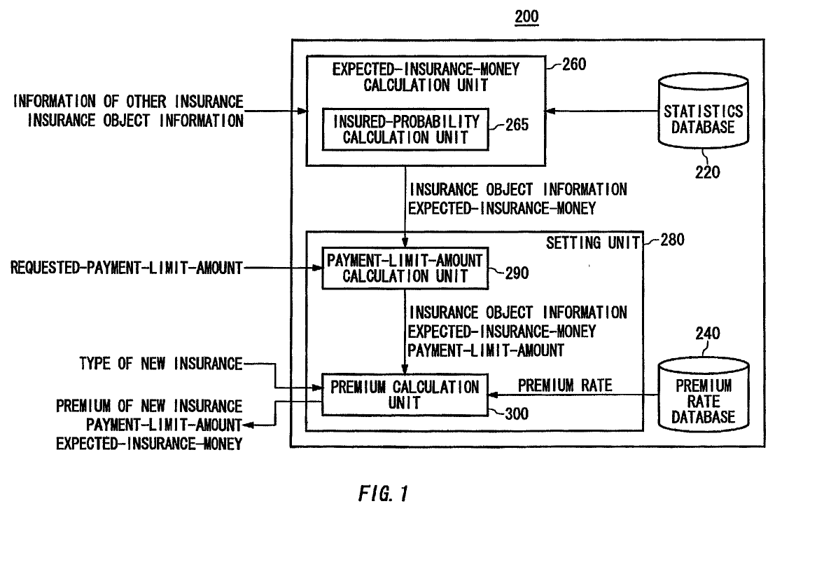

FIG. 1 shows a configuration of an insurance-determination-supporting apparatus 200 of the present embodiment. The insurance-determination-supporting apparatus 200 comprise a statistics database 220 and a premium-rate database 240. The insurance-determination-supporting apparatus 200 also comprise a first or expected-insurance-money calculation unit 260 and a setting unit 280.

The setting unit 280 has a second or payment-limit-amount calculation unit 290 and a premium calculation unit 300. The insurance-determination-supporting apparatus 200 acquires information of an insured object, i.e., an object for which new insurance is sought by a user, and information related to other insurance, i.e., other insurance which insures the object of the new insurance, from outside the insurance-determination-supporting apparatus 200.

The insurance-determination-supporting apparatus 200 further calculates, using such as statistic data, an expected-insurance-money, which is an amount of insurance compensation money that can be expected to be paid for the object of the new insurance from other insurances when a covered incident, such as an insurance accident, occurs in relation to the insured object.

The insurance-determination-supporting apparatus 200 then calculates a payment-limit-amount, i.e., the compensation limit, of the new insurance by subtracting the calculated expected-insurance-money amount from a requested payment-limit-amount, which is a payment-limit-amount requested by the customer for the object of the new insurance. As used herein, customer and/or user refer to a user making a request for insurance based on the user's specific requirements or a user that is shopping for insurance based on, for example, price and or coverage comparisons. The insurance-determination-supporting apparatus 200 then calculates the premium of the new insurance using the calculated payment-limit-amount.

Here, “other” insurance includes insurance that insures the object of the new insurance and insurance that insures other insured objects. Moreover, “other” insurance may be based on the present insured condition or a future insured condition based on an assumption. In other words, “other” insurance includes existing insurance and insurance in the future, but before the occurrence of an accident, which is determined by probability calculation.

There are various examples of other insurance that insures the object of the new insurance, such as car insurance, including insurance that insures against a traffic accident resulting in injury or death or against vehicle damage, fire insurance, transportation insurance, medical expenses insurance, and personal liability compensation insurance.

As examples of other insurance that insures other insured objects with the object of the new insurance being an indirect insured object, such as a third-party insured, there are insurance such as automobile liability insurance, casualty insurance, public liability and property damage compensation insurance, personal liability compensation insurance, and workman's accident compensation insurance. Other insurance that insures other insured objects includes all insurance that pays insurance compensation money for the object of the new insurance when a covered incident, such as an accident, occurs in relation to the insured object, except the new insurance sought for the insured object.

Moreover, the expected-insurance-money amount, which is to be deducted from the requested payment-limit-amount, may be an amount calculated by discounting the payment-limit-amount, which is calculated statistically, by a predetermined rate.

The statistics database 220 stores information such as the information related to an insured object, on which an insurance incident or accident has occurred, the insurance money, which is paid as a compensation for the insurance object, and the information related to the insurance accident. The statistics database 220 stores each information to correspond to each other.

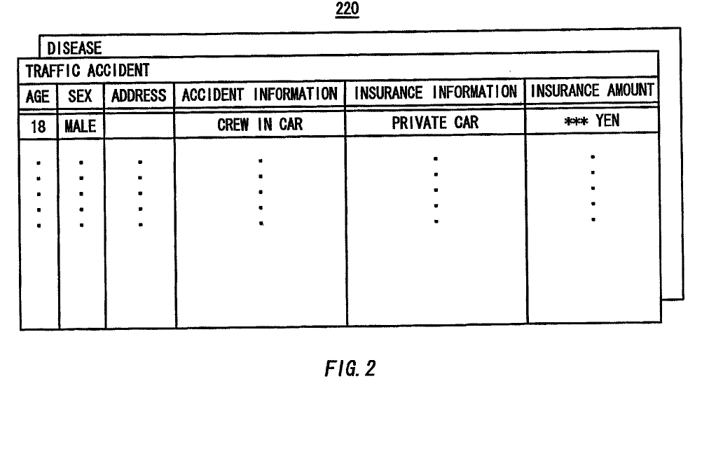

FIG. 2 shows an example of a configuration of the statistics database 220. The statistics database 220 has tables for each kind of insurance accident. Each table has an age field, a sex field, and an address field as fields for storing the information related to the insurance accident. Each table further has an accident information field, an insurance information field, and the insurance amount field. The accident information field stores the information, which is used for calculating the probability that the insurance object of the customer will have the insurance accident, among the information related to the accident which became the cause for the payment of the insurance money.

For example, the accident information field stores the information such as whether the insurance object was an insured person, was a pedestrian, a person who rode a bicycle, or a person who rode a motorcycle, in the table related to the traffic accident. The insurance information field stores the information such as whether the insurance object, which met with the insurance accident, was insured or not. If the insurance object that met with the insurance accident was insured, the insurance information field stores the information that specifies the types of the insurance that insured the insurance object. The insurance amount field stores an amount of insurance money that was paid for the insurance accident.

The statistics database 220 is not limited to the above-mentioned example. The statistics database 220 may store other information such as the vital population statistics, statistics of insurance accidents, and information of a condition where what percentage of people carry the insurance.

The premium-rate database 240 stores information related to the insurance object and the premium rate of each kind of insurance such that the information related to the insurance object and the premium rate correspond to each other.

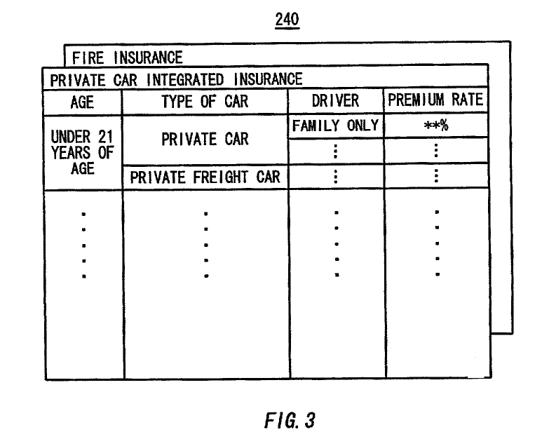

FIG. 3 shows an example of the premium-rate database 240. The premium-rate database 240 has tables for each kind of insurance. For example, the premium-rate database 240 has a table related to the private car integrated insurance that stores the premium rate that depends on the age of the insurance object, the type of car driven, and the person who drives the car.

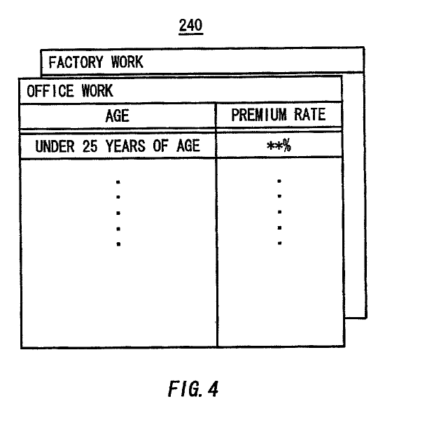

FIG. 4 shows other examples of the premium-rate database 240. The premium-rate database 240 has tables for each type of employment of the insured person such as factory work or office work. Each table is stored in the premium-rate database 240 such that the age of the insured person and the premium rate correspond to each other.

Referring to FIG. 1, the expected-insurance-money calculation unit 260 acquires the information related to the object of the new insurance, i.e, the insurance or insured object, and the information related to the other insurance that already insures the insurance object, from outside the insurance-determination-supporting apparatus 200.

Here, the information related to the insurance object includes the information for specifying the types of the insurance object such as a person, house, car, and so on, and the information peculiar for the insurance object such as an age, an address, the size of a house, the type of car, and so on. Furthermore, the information related to the other insurance includes the information of the type of the other insurance and the contract conditions of the insurance.

The expected-insurance-money calculation unit 260 calculates an expected-insurance-money, which is an expected value of the insurance amount to be paid for the insurance object from the other insurance at the time of occurrence of an insurance accident, using the information related to the insurance object of the new insurance, the information related to the other insurance which already insures the insurance object, and the data stored in the statistics database 220.

Furthermore, the expected-insurance-money calculation unit 260 has an insured probability calculation unit 265. The insured probability calculation unit 265 calculates the probability, in which the other insurance objects are insured, statistically. Thus, the expected-insurance-money calculation unit 260 further calculates the expected-insurance-money, which is to be paid for the above-mentioned insurance object of the new insurance from the other insurance that insures the other insurance objects, using the probability calculated by the insured probability calculation unit 265.

Here, as an example of the other insurance objects, there is a person who drives the car. As an example of insurance that insures the other insurance objects, there is an automobile insurance that pays insurance money for the insurance object of the new insurance when an insurance accident happens on the insurance object of the new insurance by the other insured car.

As clear from the present example, the insurance money to be paid for the damage caused to the said insurance object of the new insurance by an insurance accident is not limited only to insurance that insures the object of the new insurance.

That is, the expected-insurance-money calculation unit 260 calculates quantitatively how much compensation can be expected from other insurance regardless of the object of the other insurance.

Then, the expected-insurance-money calculation unit 260 calculates the sum of the two calculated expected-insurance-money amounts and transmits to the payment-limit-amount calculation unit 290 as a formal expected-insurance-money with the information related to the insurance object.

The payment-limit-amount calculation unit 290 receives the information related to the insurance object and the expected-insurance-money from the expected-insurance-money calculation unit 260. The payment-limit-amount calculation unit 290 also receives the requested payment-limit-amount, which is a compensation amount requested by the customer for the insurance object, from outside the insurance-determination-supporting apparatus 200.

Then, the payment-limit-amount calculation unit 290 calculates the payment-limit-amount for the new insurance by deducting the expected-insurance-money from the requested-payment-limit-amount.

Moreover, the payment-limit-amount calculation unit 290 transmits the calculated payment-limit-amount, the information related to the insurance object, and the expected-insurance-money to the premium calculation unit 300.

The premium calculation unit 300 acquires the type of the insurance policy, which is to be newly carried by the customer, from outside the insurance-determination-supporting apparatus 200. The premium calculation unit 300 also receives the information related to the insurance object, the expected-insurance-money, and the payment-limit-amount from the payment-limit-amount calculation unit 290.

The premium calculation unit 300 acquires the premium rate for the insurance object from the premium-rate database 240 using the information related to the type of the insurance, which is to be newly carried by the customer, and the information related to the insurance object. The premium calculation unit 300 then calculates the premium for the new insurance by applying the acquired premium rate to the payment-limit-amount received from the payment-limit-amount calculation unit 290. The premium calculation unit 300 then outputs the calculated premium and the payment-limit-amount to outside the insurance-determination-supporting apparatus 200, such as to the customer's terminal.

Here, the premium calculation unit 300 may output the expected-insurance-money, which is received from the payment-limit-amount calculation unit 290, to outside the insurance-determination-supporting apparatus 200, such as to the customer's terminal.

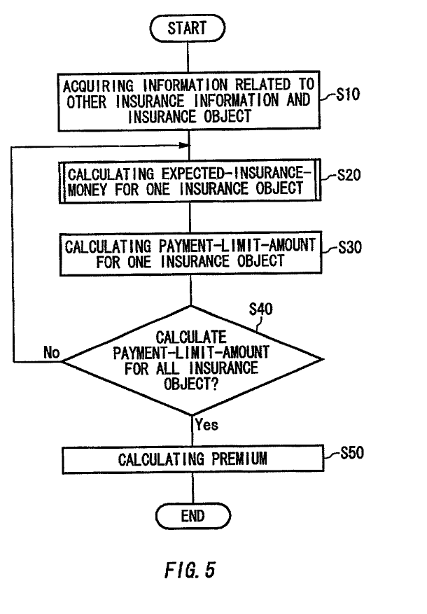

FIG. 5 shows an example of the operation of the insurance-determination-supporting apparatus 200. The insurance-determination-supporting apparatus 200 acquires the information related to the insurance object and the information related to the other insurance that insures the insurance object, using the expected-insurance-money calculation unit 260 (S10). Here, each of the insurance object and the other insurance may be plural.

The insurance-determination-supporting apparatus 200 then calculates the expected-insurance-money for one insurance object using the expected-insurance-money calculation unit 260 (S20). Next, the insurance-determination-supporting apparatus 200 calculates the payment-limit-amount for said one insurance object using the payment-limit-amount calculation unit 290 (S30).

The insurance-determination-supporting apparatus 200 then calculates the payment-limit-amount for each insurance object by performing Step 20 and Step 30 for all of the insurance objects (S40). The insurance-determination-supporting apparatus 200 calculates the premium for each of the insurance objects. The insurance-determination-supporting apparatus 200 then sets the sum of the calculated premiums as a total premium (S50).

Therefore, the customer can easily prevent carrying excessive insurance using the insurance-determination-supporting apparatus 200. Here, if the insurance-determination-supporting apparatus 200 calculates the expected-insurance-money based on statistical data, the insurance-determination-supporting apparatus 200 can prevent the customer from carrying too much insurance based on a quantitative analysis.

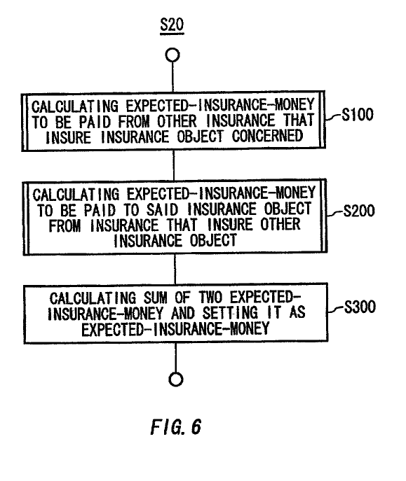

FIG. 6 shows an example of a detailed flow-chart for Step 20 in FIG. 5. The expected-insurance-money calculation unit 260 calculates the expected-insurance-money, which is to be paid from the other insurance that insures the insurance object, using the information related to the other insurance received from outside the insurance-determination-supporting apparatus 200 (S100).

The expected-insurance-money calculation unit 260 also calculates the expected-insurance-money to be paid for the insurance object from the insurance that insures other insurance objects (S200). Then, the expected-insurance-money calculation unit 260 calculates the sum of the expected-insurance-money amount calculated in Step 100 and the expected-insurance-money amount calculated in Step 200. Then, the expected-insurance-money calculation unit 260 sets the calculated sum of the amounts of the expected-insurance-money as an expected-insurance-money (S300).

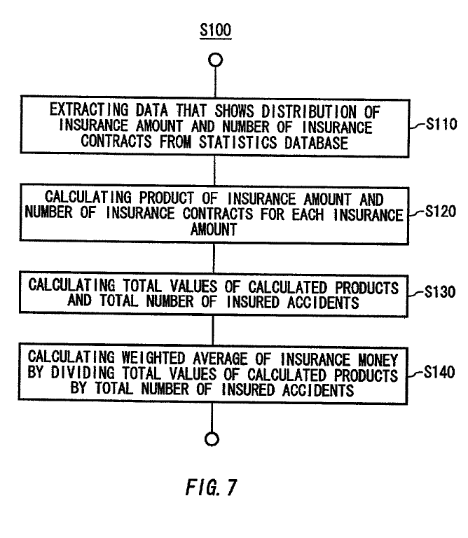

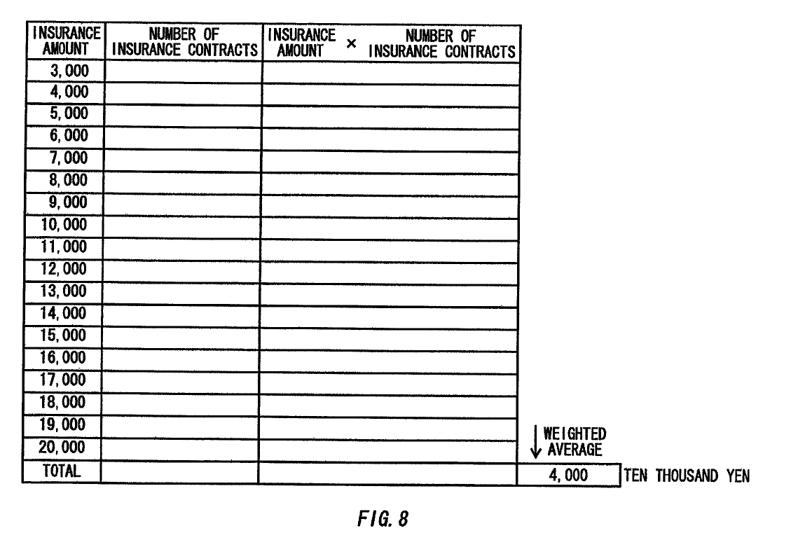

Next, details of Step 100 shown in FIG. 6 are explained using FIGS. 7 and 8. FIG. 7 shows a detailed example of Step 100 shown in FIG. 6. FIG. 8 show a table for explaining the calculation according to the operation of the expected-insurance-money calculation unit 260 shown in FIG. 7.

When the expected-insurance-money calculation unit 260 receives the information related to the insurance object and the information related to the other insurance, the expected-insurance-money calculation unit 260 extracts the distribution data of the amount of the insurance money paid by the other insurance for insurance accidents occurring on the same kinds of insurance objects (S110).

The expected-insurance-money calculation unit 260 then calculates the product of the insurance amount and the number of insurance contracts for each insurance amount (S120) as shown in FIG. 8. The expected-insurance-money calculation unit 260 then calculates the total amount of the insurance amount by calculating the sum of the calculated products and also calculates the total number of insured accidents (S130).

The expected-insurance-money calculation unit 260 then calculates the weighted average of the insurance money by dividing the total value of the insurance amount by the total number of the insured accidents (S140). The expected-insurance-money calculation unit 260 then sets the calculated weighted average of the insurance money as an expected-insurance-money.

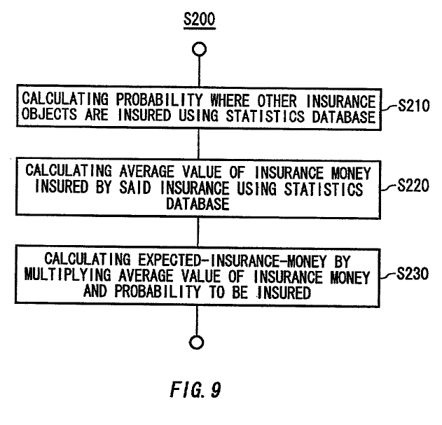

FIG. 9 shows a detailed example of Step 200 shown in FIG. 6. The expected-insurance-money calculation unit 260 calculates the probability, in which the other insurance objects are insured, using the statistics database 220 (210). The expected-insurance-money calculation unit 260 also calculates the average value of the insurance money, which is to be paid by the insurance that insures other insurance objects, using the statistics database 220 (S220). The expected-insurance-money calculation unit 260 then calculates the expected-insurance-money to be paid by the insurance that insures other insurance objects by multiplying the average value of the insurance money calculated in Step 220 and the probability calculated in Step 210 (S230).

The expected-insurance-money calculation unit 260 calculates the expected-insurance-money considering the insurance money to be paid by the insurance which insures the other insurance objects such as the person who causes the car accident. The expected-insurance-money calculation unit 260 thus can prevent the customer from carrying excessive insurance.

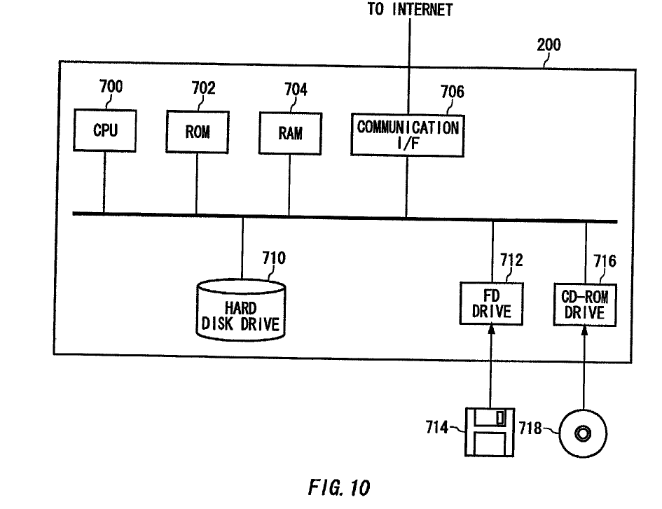

FIG. 10 shows a configuration of hardware of the insurance-determination-supporting apparatus 200. The insurance-determination-supporting apparatus 200 comprises a CPU 700, a ROM 700, a RAM 704, and a communication interface 706. The CPU 700 operates based on the program stored in the ROM 702 and the RAM 704. The communication interface 706 communicates with outside the insurance-determination-supporting apparatus 200 via a communications network such as the Internet or an Intranet. The hard disk drive 710, which is one of the examples of the storing apparatus, stores setting information and a program that operates the CPU 700.

The floppy disk drive 712 reads out the data or program from the floppy disk 714 and provides it to the CPU 700. The CD-ROM drive 716 reads out the data or program from the CD-ROM 718 and provides it to the CPU 700. The communication interface 706 transmits the data while connected to an information communication network, such as the Internet.

The software executed by the CPU 700 may be stored in a recording medium such as the floppy disk 714 or the CD-ROM 718 and provided to the user in the form of recording medium. The software stored in the recording medium may be compressed or uncompressed. The software stored in the recording medium is installed to the hard disk drive 710 from the recording medium and is read out to the RAM 704 and executed by the CPU 700.

The software, which is stored in the recording medium and provided to the user and is installed to the hard disk drive 710, comprises an expected-insurance-money calculation module, an insured probability calculation module, and a setting module as functional components. The setting module has a payment-limit-amount calculation module and a premium calculation module. Because the processes executed by the CPU according to the instructions of each of above-mentioned modules are same as the processes executed by the functions and the operations of the corresponding units in the insurance-determination-supporting apparatus 200 shown in FIG. 1, the explanation here is abbreviated.

The floppy disk 714 or the CD-ROM 718 shown in FIG. 10, which are examples of a recording medium, can store a part or all of the functions of the operations of the insurance-determination-supporting apparatus 200 explained in the all of the present embodiments.

The program may be directly read out from the recording medium to the RAM 704 and executed by the CPU 700. The program also may be just installed into the hard disk drive 710 and then read out to the RAM 704 and executed by the CPU 700. Furthermore, the above-mentioned program may be stored in a single recording medium or stored in a plurality of recording media. Moreover, the modules stored in the recording medium may provide each function by cooperating with an operating system. For example, the module may request the operation system to perform part or all of the functions and provide the functions based on the response sent from the operation system.

An optical recording medium such as DVD, a magnetic recording medium, and a photo magnetic recording medium, tape medium, or a semiconductor memory such as an IC card or memory card can also be used as a recording medium. Moreover, the storing apparatus such as the hard disk drive 710 or the RAM 704 provided in a server system, which is connected to a private communication network or the Internet, may be used as a recording medium, and the program may be provided to the insurance-determination-supporting apparatus 200 via the communication network.

FIG. 111 shows a configuration of another embodiment of the insurance-determination-supporting apparatus according to the present invention. The insurance-determination-supporting apparatus 201 comprises a statistics database 220 and a premium-rate database 240 as databases. The insurance-determination-supporting apparatus 201 also comprises an expected-insurance-money calculation unit 260 and a setting unit 280 as functional units. The setting unit 280 has a discount setting unit 295 and a premium calculation unit 300. Because the configurations of the functional units excluding the configuration of the setting unit 280 of the insurance-determination-supporting apparatus 201 are almost the same as the configurations of the insurance-determination-supporting apparatus 200 shown in FIG. 1, the explanation here is abbreviated.

When the discount setting unit 295 receives the insurance object information and the expected-insurance-money from the expected-insurance-money calculation unit 260, the discount setting unit 295 sets a discount rate or a discount amount of the premium for the new insurance using the received expected-insurance-money.

For example, the discount setting unit 295 sets the discount rate or the discount amount using a table that contains the information of the expected-insurance-money and the corresponding discount rate or the discount amount. In this case, the discount setting unit 295 may prepare the table for each of the classifications of the requested-payment-limit-amounts as the above-mentioned table and receive the requested-payment-limit-amount from outside the insurance-determination-supporting apparatus 201 and set the discount rate or the discount amount using the received requested-payment-limit-amount and the prepared tables. Then, the discount setting unit 295 transmits the discount rate or the discount amount to the premium calculation unit 300.

The premium calculation unit 300 acquires the types of the insurance, which is to be newly carried by the customer, and the requested-payment-limit-amount from the outside and also receives the information related to the insurance object, the expected-insurance-money, and discount rate or the discount amount from the discount setting unit 295.

Here, when the discount setting unit 295 receives the requested-payment-limit-amount from outside the insurance-determination-supporting apparatus 201, the premium calculation unit 300 receives the requested-payment-limit-amount from the discount setting unit 295. The premium calculation unit 300 acquires the premium rate for the insurance object from the premium-rate database 240, using the information related to the type of the insurance received from outside and the information related to the insurance object received from the discount setting unit 295.

When the premium calculation unit 300 receives the discount rate from the discount setting unit 295, the premium calculation unit 300 calculates the premium rate by adding the premium rate acquired from the premium-rate database 240 to the discount rate received from the discount setting unit 295. The premium calculation unit 300 then calculates the premium for the insurance, which is to be newly carried by the customer, by applying the calculated premium rate to the requested-payment-limit-amount.

When the premium calculation unit 300 receives the discount amount from the discount setting unit 295, the premium calculation unit 300 calculates a temporary premium for the insurance, which is to be newly carried by the customer, by applying the premium rate acquired from the premium-rate database 240 to the requested-payment-limit-amount. The premium calculation unit 300 calculates the premium by deducting the discount amount from the calculated temporary premium.

The premium calculation unit 300 then outputs the calculated premium and the payment-limit-amount to outside the insurance-determination-supporting apparatus 201, such as to the terminal of the customer. Here, the premium calculation unit 300 may output the expected-insurance-money received from the discount setting unit 295 to outside the insurance-determination-supporting apparatus 201, such as to the terminal of the customer.

Therefore, the customer can easily prevent double payment of the premium using the insurance-determination-supporting apparatus 201. If the insurance-determination-supporting apparatus 201 calculates the expected-insurance-money based on statistical data, the customer who uses the insurance-determination-supporting apparatus 201 can prevent double payment of the premium on a quantitative basis.

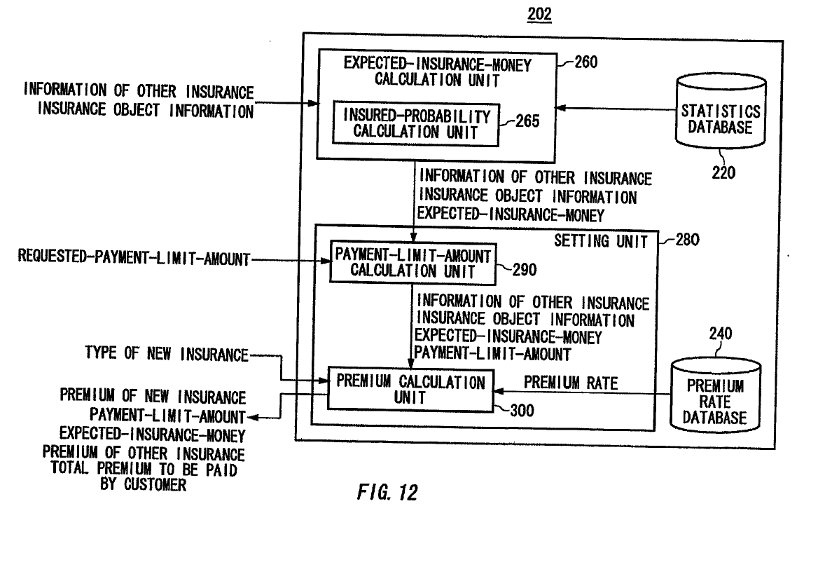

FIG. 12 shows a configuration of yet another embodiment of the insurance-determination-supporting apparatus according to the present invention. Because the configuration of the insurance-determination-supporting apparatus 202 in FIG. 12, except for the configuration of the premium calculation unit 300, is almost the same as the configuration of the insurance-determination-supporting apparatus 200 shown in FIG. 1, the explanation here is abbreviated.

As shown in FIG. 12, the payment-limit-amount calculation unit 290 acquires the information of other insurance from the insured probability calculation unit 265, and the premium calculation unit 300 acquires the information of other insurance from the payment-limit-amount calculation unit 290.

The premium calculation unit 300 acquires the types of the insurance policy, which is to be newly carried by the customer, from outside the insurance-determination-supporting apparatus 202. The premium calculation unit 300 also receives the information related to the insurance object, the expected-insurance-money, and the payment-limit-amount from the payment-limit-amount calculation unit 290.

The premium calculation unit 300 acquires the premium rate for the insurance object from the premium-rate database 240 using the information related to the types of the insurance, which is to be newly carried by the customer, and the information related to the insurance object. The premium calculation unit 300 then calculates the premium for the new insurance by applying the acquired premium rate to the payment-limit-amount received from the payment-limit-amount calculation unit 290.

The premium calculation unit 300 calculates a total premium, which is a total amount of the premium of the insurance and the premiums of other insurance paid by the user. The premium calculation unit 300 then calculates the amount of the expected-insurance-money and the payment-limit-amount so that the total premium becomes a minimum value. The premium calculation unit 300 then recalculates the premium of the insurance and the premiums of the other insurance based on the calculated expected-insurance-money and the payment-limit-amount.

The premium calculation unit 300 then outputs the calculated premium of new insurance, the payment-limit-amount, the expected-insurance money, the premium of other insurance, and the total premium to be paid by the customer to outside the insurance-determination-supporting apparatus 202 such as to the customer's terminal.

As clear from the above explanation, the present insurance-determination-supporting apparatus, the method for supporting an insurance contract, and the program thereof can prevent a customer from carrying excessive insurance or making double payment of the premium.

Although the present invention has been described by way of exemplary embodiments, it should be understood that those skilled in the art might make many changes and substitutions without departing from the spirit and the scope of the present invention which is defined only by the appended claims. For example, the expected-insurance-money calculation unit 260 may calculate the expected-insurance-money using the present insured condition or a future insured condition based on an assumption.

1. An apparatus that supports a user in determining insurance that the user seeks for an insured object, comprising:
a first calculation unit that calculates an expected amount of insurance money, which is insurance money expected to be paid for said object of said insurance from other insurance; and
a setting unit that sets a premium for said insurance sought for said object using said expected-insurance-money calculated by said first calculation unit.

2. An apparatus as claimed in claim 1, wherein:
said setting unit includes:
a second calculation unit that calculates a payment-limit-amount, which is a compensation amount of insurance money to be paid to the user by said insurance sought for said object, using said expected-insurance-money; and
a premium calculation unit that calculates said premium for said insurance sought for said object using said payment-limit-amount.

3. An apparatus as claimed in claim 2, wherein:
said first calculation unit receives information related to said insured object and calculates said expected-insurance-money using said received information; and
said second calculation unit receives a requested payment-limit-amount for said insured object, which is a compensation amount of insurance sought by the user related to said insured object, and calculates said payment-limit-amount using said requested payment-limit-amount and said expected-insurance-money.

4. An apparatus as claimed in claim 1, wherein the apparatus refers to insurance that insures said insured object, except said insurance sought for said object, as said other insurance.

5. An apparatus as claimed in claim 1, wherein the apparatus refers to insurance that insures objects other than said insured object, as said other insurance.

6. An apparatus as claimed in claim 5, wherein:
said first calculation unit includes:
a probability calculation unit that calculates a probability of receiving insurance money from said other insurance that insures said other insured objects; and
said first calculation unit calculates said expected-insurance-money using said probability calculated by said probability calculation unit.

7. An apparatus as claimed in claim 2, wherein:
said first calculation unit calculates said expected-insurance-money for each of a plurality of said insured objects, when there is said plurality of said insured objects; and
said second calculation unit calculates said payment-limit-amount using said each calculated expected-insurance-money; and
said premium calculation unit calculates said premium using said payment-limit-amount for each insured object of said plurality of insured objects.

8. An apparatus as claimed in claim 2, wherein:
said premium calculation unit
calculates a total premium amount, which is a total amount of said premium for said insurance sought for said object and premiums for said other insurance paid by the user,
recalculates said expected-insurance-money and said payment-limit-amount so that said total premium becomes a minimum value,
and recalculates said premium for said insurance sought for said object and said premiums for said other insurance based on said recalculated expected-insurance-money and said payment-limit-amount.

9. An apparatus as claimed in claim 1, wherein:
said setting unit includes:
a discount setting unit that sets a discount rate or a discount amount, using said expected-insurance-money, for said premium for said insurance sought for said insured object; and
a premium calculation unit that calculates said premium for said insurance sought for said object using said discount rate or said discount amount.

10. An apparatus as claimed in claim 9, wherein:
said first calculation unit receives information related to said insured object and calculates said expected-insurance-money using said received information; and
said discount setting unit receives a requested payment-limit-amount for said insured object, which is a compensation amount of insurance sought by the user related to said insured object, and sets said discount rate or said discount amount for said premium using said requested payment-limit-amount and said expected-insurance-money.

11. An apparatus as claimed in claim 9, wherein:
said first calculation unit calculates said expected-insurance-money for each of a plurality of said insured objects, when there is said plurality of said insured objects;
said discount setting unit sets said discount rate or said discount amount using said each calculated expected-insurance-money; and
said premium calculation unit calculates said premium using said discount rate or said discount amount for each of said plurality of insured objects.

12. A method for supporting a user in obtaining insurance that the user seeks for an insured object, comprising:
calculating an expected amount of insurance money, which is insurance money expected to be paid for said insured object of said insurance from other insurance;
calculating a premium for said insurance sought for said object using said expected-insurance-money amount; and
notifying said calculated premium to the user who seeks insurance for the insured object.

13. A method as claimed in claim 11, wherein:
said calculating said premium includes:
calculating a payment-limit-amount, which is a compensation amount of insurance money to be paid to the user by said insurance sought for said object, using said expected-insurance-money; and
calculating said premium for said insurance sought for said object using said payment-limit-amount.

14. A method as claimed in claim 13, wherein:
said calculating said expected-insurance-money receives information related to said insured object and calculates said expected-insurance-money using said received information; and
said calculating said payment-limit-amount receives a requested-payment-limit-amount for said insured object, which is a compensation amount of insurance sought by the user related to said insured object, and calculates said payment-limit-amount using said requested-payment-limit-amount and said expected-insurance-money.

15. A method as claimed in claim 12, wherein said calculating said expected-insurance-money refers to insurance that insures said insured object, except said insurance sought for said object, as said other insurance.

16. A method as claimed in claim 12, wherein said calculating said expected-insurance-money refers to insurance that insures objects other than said insured object, as said other insurance.

17. A method as claimed in claim 16, wherein:
said calculating said expected-insurance-money includes calculating a probability of receiving insurance money from said other insurance that insures said other insured objects; and
said calculating said expected-insurance-money calculates said expected-insurance-money using said calculated probability.

18. A method as claimed in claim 13, wherein:
said calculating said expected-insurance-money calculates said expected-insurance-money for each of plurality of said insurance objects when there is a plurality of said insurance objects; and
said calculating said payment-limit-amount unit calculates said payment-limit-amount using said calculated expected-insurance-money; and
said calculating said premium calculates said premium using said payment-limit-amount for each of said plurality of insurance objects.

19. A method as claimed in claim 13, wherein:
said calculating said premium
calculates a total premium amount, which is a total amount of said premium for said insurance sought for said object and premiums for said other insurance paid by the user,
recalculates said expected-insurance-money and said payment-limit-amount so that said total premium becomes a minimum value, and
calculates said premium for said insurance sought for said object and said premiums for said other insurance based on said recalculated expected-insurance-money and said payment-limit-amount.

20. A method as claimed in claim 12, wherein:
said calculating said premium includes:
setting a discount rate or a discount amount, using said expected-insurance-money, for said premium for said insurance sought for said insured object; and
calculating said premium for said insurance sought for said object using said discount rate or said discount amount.

21. A method as claimed in claim 20, wherein:
said calculating said expected-insurance-money receives information related to said insured object and calculates said expected-insurance-money using said received information; and
said setting said discount rate or a discount amount receives a requested-payment-limit-amount for said insured object, which is a compensation amount of insurance sought by the user related to said insured object, and sets said discount rate or said discount amount for said premium using said requested-payment-limit-amount and said expected-insurance-money.

22. A method as claimed in claim 20, wherein:
said calculating said expected-insurance-money calculates said expected-insurance-money for each of a plurality of said insured objects when there is a plurality of said insured objects;
said setting discount sets said discount rate or said discount amount using said each calculated expected-insurance-money; and
said calculating said premium calculates said premium using said discount rate or said discount amount for each of said plurality of insured objects.

23. A recording medium that stores a program executable by a computer for supporting a user in determining insurance, comprising:
a first calculation module operable to calculate an expected amount of insurance money, which is insurance money expected to be paid for an object of said insurance sought by the user, from other insurance when a covered incident occurs related to said object; and
a premium calculation module operable to calculate a premium for said insurance sought for said object using said expected-insurance-money amount calculated by said first calculation module.
